(19) United States
(12) Patent Application Publication
(10) Pub. No.: US 2026/0001417 A1
(43) Pub. Date: Jan. 1, 2026

(54) VEHICLE CHARGING SYSTEM FOR AN ELECTRIC VEHICLE HAVING ARC DETECTION

(71) Applicant: TE Connectivity Solutions GmbH, Schaffhausen (CH)

(72) Inventors: David Bruce Sarraf, Middletown, PA (US); Nathan Philip Myer, Middletown, PA (US); Robin Wesson, Middletown, PA (US); Paul Angell, Middletown, PA (US)

(21) Appl. No.: 18/976,530

(22) Filed: Dec. 11, 2024

Related U.S. Application Data
(60) Provisional application No. 63/665,331, filed on Jun. 28, 2024.

(51) Int. Cl. B60L 53/16; B60L 53/62

(52) U.S. Cl. CPC B60L 53/16; B60L 53/62

(57) ABSTRACT

A vehicle charging system for an electric vehicle includes charging terminals held in a housing being connected to corresponding power conductors to form power transmission lines. The vehicle charging system includes a charging controller for controlling vehicle charging along the power transmission lines. The vehicle charging system includes an arc detection antenna coupled to the charging controller. The arc detection antenna is positioned proximate to the power transmission lines for detecting arc signatures along the power transmission lines from an arc event. The arc detection antenna transmits an arc output signal to the charging controller based on detection of the arc signature.

### CROSS REFERENCE TO RELATED APPLICATIONS

This application claims benefit to U.S. Application No. 63/665,331, filed 28-Jun.-2024, the subject matter of which is herein incorporated by reference in its entirety.

### BACKGROUND OF THE INVENTION

The subject matter herein relates generally to vehicle charging systems.

Electric vehicles (EV) and hybrid electric vehicles (HEV) include battery systems for operating the vehicles. The battery systems are charged by a vehicle charging system. For example, a charging connector, which is coupled to a power source, is connected to a charging inlet assembly of the vehicle to charge the battery. Known vehicle charging systems are not without disadvantages. For instance, the temperature of the terminals increase during charging, which may lead to damage to the charging components. In some instances, arcing may occur between the charging components, which can damage the charging connector and the charging inlet assembly. Arc monitoring of the signals on the power transmission lines may be difficult, such as due to noise on the power transmission lines leading to false positive arc detection. For example, during charging, the charging connector produces a DC current to charge the battery. The charging current uses a switching power supply, which superimposes a small AC ripple current on the DC charging current. While the ripple current is of no consequence to the battery, the frequency of the AC ripple current may be in a range that overlaps the frequency spectrum typical of an arc (100-1500 kHz), such as between 50-1000 kHz. The overlap makes spectrum analysis problematic.

A need remains for an arc detection method for a vehicle charging system of an electric vehicle.

### BRIEF DESCRIPTION OF THE INVENTION

In one embodiment, a vehicle charging system for an electric vehicle is provided and includes a housing having a mating end for mating with a charging component for the electric vehicle. The housing includes an internal cavity. The vehicle charging system includes charging terminals held by the housing in the internal cavity. Each charging terminal includes a mating end for mating with the charging component. The charging terminals are connected to corresponding power conductors to form power transmission lines. The vehicle charging system includes a charging controller for controlling vehicle charging along the power transmission lines. The vehicle charging system includes an arc detection antenna coupled to the charging controller. The arc detection antenna is positioned proximate to the power transmission lines for detecting arc signatures along the power transmission lines from an arc event. The arc detection antenna transmits an arc output signal to the charging controller based on detection of the arc signature.

In another embodiment, a vehicle charging system for an electric vehicle is provided and includes a housing having a mating end for mating with a charging component for the electric vehicle. The housing includes an internal cavity. The vehicle charging system includes charging terminals held by the housing in the internal cavity. Each charging terminal includes a mating end for mating with the charging component. The charging terminals are connected to corresponding power conductors to form power transmission lines. The vehicle charging system includes a charging controller for controlling vehicle charging along the power transmission lines. The vehicle charging system includes an arc detection antenna coupled to the charging controller. The arc detection antenna is positioned proximate to the power transmission lines for detecting arc signatures along the power transmission lines from an arc event. The arc detection antenna determines magnitudes of arc signals on the power transmission lines and determines phases of the arc signals on the power transmission lines. The arc detection antenna discriminates between differential mode signals and common mode signals transmitted along the power transmission lines based on the magnitudes of the arc signals on the power transmission lines and the phases of the arc signals on the power transmission lines. The arc detection antenna processes the magnitudes. The phases, and the modes to generate an arc output signal. The arc output signal is transmitted to the charging controller to control the vehicle charging.

In a further embodiment, a charging inlet assembly for an electric vehicle is provided and includes a housing extending between a front and a rear. The housing has a chamber at the rear. The housing has a power connector at the front for receiving a charging connector. The power connector includes terminal channels between the front and the rear. The charging inlet assembly includes charging terminals received in the corresponding terminal channels. Each of the charging terminals includes a mating pin and a terminating end opposite the mating pin. The mating pin is positioned in the corresponding terminal channel for mating with the charging connector. The terminating end is positioned in the chamber at the rear of the housing and being connected to a power conductor to form a power transmission line. The charging inlet assembly includes a charging controller for controlling vehicle charging along the power transmission lines during a charging operation. The charging inlet assembly includes an arc detection antenna coupled to the charging controller. The arc detection antenna is positioned proximate to the power transmission lines for detecting arc signatures along the power transmission lines from an arc event. The arc detection antenna determines magnitudes of arc signals on the power transmission lines and determines phases of the arc signals on the power transmission lines. The arc detection antenna discriminates between differential mode signals and common mode signals transmitted along the power transmission lines based on the magnitudes of the arc signals on the power transmission lines and the phases of the arc signals on the power transmission lines. The arc detection antenna processes the magnitudes. The phases, and the modes to generate an arc output signal. The arc output signal is transmitted to the charging controller to control the vehicle charging.

### BRIEF DESCRIPTION OF THE DRAWINGS

FIG. 1 is a schematic view of a vehicle charging system in accordance with an exemplary embodiment.

FIG. 2 is a front perspective view of a charging component in accordance with an exemplary embodiment.

FIG. 3 is a rear perspective view of the charging component in accordance with an exemplary embodiment.

FIG. 4 is a perspective view of the charging controller in accordance with an exemplary embodiment.

FIG. 5 is a cross-sectional view of the charging component in accordance with an exemplary embodiment showing a second charging component coupled to the charging component.

FIG. 6 is a cross sectional view of the charging component in accordance with an exemplary embodiment showing the second charging component coupled to the charging component.

FIG. 7 is a schematic view of the vehicle charging system in accordance with an exemplary embodiment in a differential mode.

FIG. 8 is a schematic view of the vehicle charging system in accordance with an exemplary embodiment in a common mode.

FIG. 9 is a schematic view of a portion of the charging inlet assembly showing an arrangement of the arc detection antenna in accordance with an exemplary embodiment in a first mode (differential mode).

FIG. 10 is a schematic view of a portion of the charging inlet assembly showing an arrangement of the arc detection antenna in accordance with an exemplary embodiment in a second mode (common mode).

FIG. 11 is a schematic view of a portion of the charging inlet assembly showing an arrangement of the arc detection antenna in accordance with an exemplary embodiment in a first mode (differential mode).

FIG. 12 is a schematic view of a portion of the charging inlet assembly showing an arrangement of the arc detection antenna in accordance with an exemplary embodiment in a second mode (common mode).

### DETAILED DESCRIPTION OF THE INVENTION

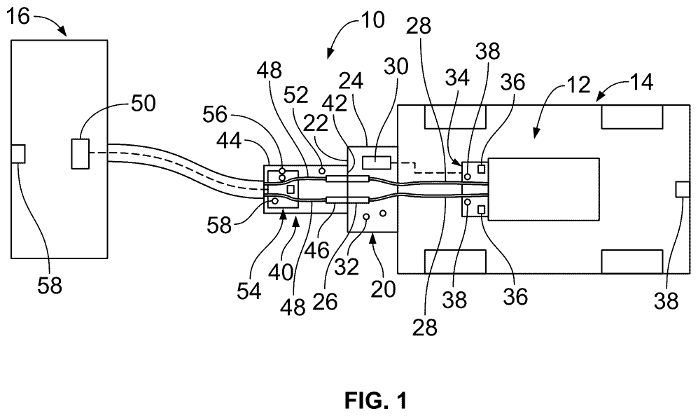

FIG. 1 is a schematic view of a vehicle charging system 10 in accordance with an exemplary embodiment. The vehicle charging system 10 is used for charging a battery system 12 of a vehicle 14, such as an electric vehicle or a hybrid electric vehicle. The vehicle charging system 10 includes a first charging component 20 and a second charging component 40. The first and second charging components 20, 40 are coupled together to charge the battery system 12 of the vehicle 14. In an exemplary embodiment, the first charging component 20 is coupled to the vehicle 14 and the second charging component 40 is coupled to a power supply 16 used for charging the battery system 12 of the vehicle 14. For example, the first charging component 20 may be a charging inlet assembly 22 mounted to the vehicle 14 and the second charging component 40 may be a charging connector 42 (for example, charging plug) which may be provided at a charging station or coupled to the building wiring of the home or building where the vehicle 14 is parked.

The first charging component 20 includes a housing 24 holding a plurality of charging terminals 26 and power conductors 28 coupled to the charging terminals 26. The charging terminals 26 may be DC charging terminals and/or AC charging terminals. The power conductors 28 may be power cables, busbars, or other types of conductors.

The first charging component 20 includes a charging controller 30, which may be used to control vehicle charging. For example, the charging controller 30 may control power supplied along the charging terminals 26. The charging controller 30 may communicate with the second charging component 40, such as to control the second charging component 40. For example, the charging controller 30 may cause the second charging component 40 to turn on the power supply, turn off the power supply, increase power supply, and/or decrease power supply.

In an exemplary embodiment, the first charging component 20 includes a temperature sensor 32 operably coupled to the charging controller 30 to monitor a temperature of the charging terminals 26. The vehicle charging may be controlled based on the temperature readings of the temperature sensor 32. The temperature sensor 32 may be used for arc detection, such as by monitoring for a spike in temperature or a temperature above a threshold temperature, which may be higher than a normal operating temperature range.

In an exemplary embodiment, the first charging component 20 includes an arc detection antenna 34 operably coupled to the charging controller 30 to monitor for electromagnetic fields or signals on the power transmission lines. For example, the arc detection antenna 34 may monitor for charging currents or signals introduced into the power transmission lines. The arc detection antenna 34 may monitor for arc signatures from an arc event transmitted along the power transmission lines within the first charging component 20, such as at the charging terminal 26 and/or along the power conductors 28. The arc detection antenna 34 may monitor for other signals, such as from external sources, introduced into the power transmission lines. In an exemplary embodiment, the arc detection antenna 34 exploits the parallel, closely spaced arrangement of the power transmission lines to discriminate between the types of signals and/or the amplitudes of signals detected on the power transmission lines, such as to discriminate the source of the signals (for example, normal charging vs arc and/or from charging vs external source). The arc detection antenna 34 is operably coupled to the charging controller 30 to control the vehicle charging, such as based on detected arc signals. For example, when the arc event is detected, the charging controller 30 may immediately shut off the power supply to stop the charging process and extinguish the arc. The charging controller may communicate with the second charging component 40, such as to shut off the power supply to stop the charging process. In an exemplary embodiment, the arc detection antenna 34 is able to identify false positive arc events. For example, the arc detection antenna 34 is operable in different modes to differentiate arc signatures to identify false positive arc events to control the charging operation, such as to maintain the charging process if the arc event is identified as a false positive. In an exemplary embodiment, the arc detection antenna 34 discriminates between common mode and differential mode signals to identify false positive arc events. For example, in the common mode, the arc detection antenna 34 is able to identify effects of external signals on the power transmission lines to identify false positive arc signatures. In the differential mode, the arc detection antenna 34 is able to identify effects of arc signals on the power transmission lines, such as to confirm that arc signals occur on the power transmission lines. The arc detection antenna 34 may determines magnitudes of arc signals on the power transmission lines and may determine phases of the arc signals on the power transmission lines.

In an exemplary embodiment, the arc detection antenna 34 includes one or more antenna elements 36 located proximate to the power transmission line(s) and one or more antenna circuits 38 processing signals from the antenna elements 36. In an exemplary embodiment, the antenna elements 36 may include e-field antenna elements and/or b-field antenna elements. The antenna elements 36 may measure electrostatic signals. The antenna elements 36 may measure magnetic signals. Other types of antenna elements may be used in alternative embodiments. In an exemplary embodiment, the antenna circuits 38 include different antenna circuits 38 for detecting signals in different modes. The antenna circuits 38 may include different antenna circuits 38 for detecting signals on different power transmission lines. The different antenna circuits 38 may detect signals in different frequency ranges. The antenna circuits 38 may include processing devices, such as a digital signal processor, a neural network, frequency diplexers, and the like, to process the signals.

The arc detection antenna 34 (and/or components of the arc detection antenna 34) may be provided at various locations within the vehicle charging system 10. For example, the arc detection antenna 34 may be located in or on the first charging component 20. In other various embodiments, the arc detection antenna 34 may be located in or on the vehicle 14, such as in or on the battery system 12. For example, the arc detection antenna 34 may be incorporated in a battery distribution unit (BDU) or other component of the battery system 12.

The second charging component 40 includes a housing 44 holding a plurality of charging terminals 46 and power conductors 48 coupled to the charging terminals 26. The charging terminals 46 are configured to be mated with the charging terminals 26. In various embodiments, the charging terminals 46 are socket terminals and the charging terminals 26 are pin terminals; however, other types of terminals may be used in alternative embodiments. The charging terminals 46 may be DC charging terminals and or AC charging terminals. The power conductors 48 may be power cables, busbars, or other types of conductors.

The second charging component 40 includes a charging controller 50, which may be used to control vehicle charging. For example, the charging controller 50 may control power supply along the charging terminals 46. The charging controller 50 may communicate with the first charging component 20. The charging controller 50 may turn on the power supply, turn off the power supply, increase the power supply, and/or decrease the power supply. The charging controller 50 may control the voltage and/or current supplied by the second charging component 40.

In an exemplary embodiment, the second charging component 40 includes a temperature sensor 52 operably coupled to the charging controller 50 to monitor a temperature of the charging terminals 46. The vehicle charging may be controlled based on the temperature readings of the temperature sensor 52. The temperature sensor 52 may be used for arc detection, such as by monitoring for a spike in temperature or a temperature above a threshold temperature, which may be higher than a normal operating temperature range.

In an exemplary embodiment, the second charging component 40 includes an arc detection antenna 54 operably coupled to the charging controller 50 to monitor current transmitted along the power transmission lines within the second charging component 40, such as at the charging terminal 46 and/or along the power conductors 48. The arc detection antenna 54 is operably coupled to the charging controller 50 to control the vehicle charging, such as based on the monitored current and/or based on detection of an arc event by the arc detection antenna 54. For example, when the arc event is detected, the charging controller 50 may immediately shut off the power supply to stop the charging process and extinguish the arc. The charging controller 50 may communicate with the second charging component 40, such as the charging controller 50, to shut off the power supply to stop the charging process. In an exemplary embodiment, the arc detection antenna 54 is able to identify false positive arc events. For example, the arc detection antenna 54 is operable in different modes to differentiate arc signatures to identify false positive arc events to control the charging operation, such as to maintain the charging process if the arc event is identified as a false positive. In an exemplary embodiment, the arc detection antenna 54 discriminates between common mode and differential mode signals to identify false positive arc events. For example, in the differential mode, the arc detection antenna 54 is able to identify effects of inverter ripple signals on the power transmission lines to identify false positive arc signatures. The arc detection antenna 54 may identify other, external signals on the power transmission lines, which may be induced from sources other than the charging signals. In the common mode, the arc detection antenna 54 is able to identify effects of arc signals on the power transmission lines, such as to confirm that arc signals occur on the power transmission lines. The arc detection antenna 54 may determines magnitudes of arc signals on the power transmission lines and may determine phases of the arc signals on the power transmission lines.

In an exemplary embodiment, the arc detection antenna 54 includes one or more antenna elements 56 located proximate to the power transmission line(s) and one or more antenna circuits 58 processing signals from the antenna elements 56. In an exemplary embodiment, the antenna elements 56 may include e-field antenna elements and/or b-field antenna elements. The antenna elements 56 may measure electrostatic signals. The antenna elements 56 may measure magnetic signals. Other types of antenna elements may be used in alternative embodiments. In an exemplary embodiment, the antenna circuits 58 include different antenna circuits 58 for detecting signals in different modes. The antenna circuits 58 may include different antenna circuits 58 for detecting signals on different power transmission lines. The different antenna circuits 58 may detect signals in different frequency ranges. The antenna circuits 58 may include processing devices, such as a digital signal processor, a neural network, frequency diplexers, and the like, to process the signals.

The arc detection antenna 54 (and/or components of the arc detection antenna 54) may be provided at various locations within the vehicle charging system 10. For example, the arc detection antenna 54 may be located in or on the second charging component 40. For example, the arc detection antenna 54 may be located in or on the charging plug. In other various embodiments, the arc detection antenna 54 may be located in or on the power supply 16, such as in or on the charging station.

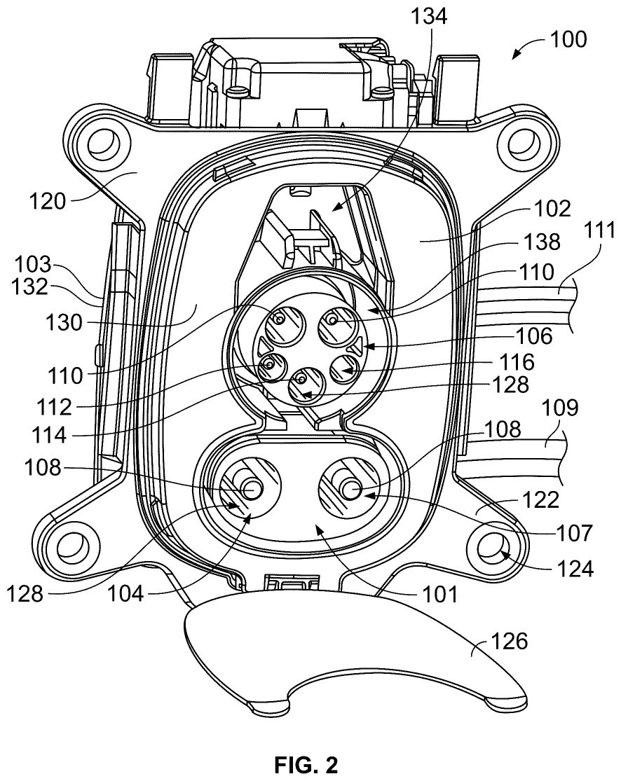

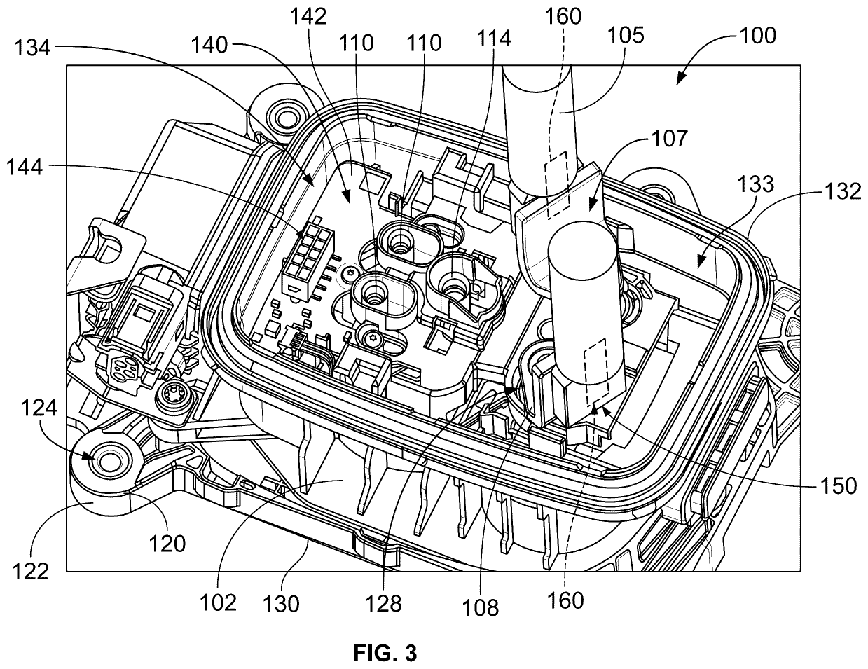

FIG. 2 is a front perspective view of a charging component 100 in accordance with an exemplary embodiment. FIG. 3 is a rear perspective view of the charging component 100 in accordance with an exemplary embodiment. In the illustrated embodiment, the charging component 100 is a charging inlet assembly and may be referred to hereinafter as a charging inlet assembly 100. The charging inlet assembly 100 is configured to be mated with a complimentary charging component (not shown), such as a charging connector or plug charger.

The charging inlet assembly 100 defines a power connector 101 configured to be electrically connected to the charging connector for charging a battery system of a vehicle, such as an electric vehicle (EV) or hybrid electric vehicle (HEV). In an exemplary embodiment, the charging inlet assembly 100 is configured for mating with a DC fast charging connector, such as the SAE combo CCS charging connector or the NACS charging connector, in addition to AC charging connectors, such as the SAE J1772 charging connector. In various embodiments, the charging inlet assembly 100 has a CCS1 (5 pin) AC configuration. In other various embodiments, the charging inlet assembly 100 may have a CCS2 (7 pin) AC configuration. Other standard inlet configurations may be used in alternative embodiments, such as the NACS configuration.

The charging inlet assembly 100 includes a housing 102 configured to be mounted in the vehicle. The housing 102 forms a portion of the power connector 101 for mating with the charging connector. A rear cover 103 (shown in FIG. 2 but removed in FIG. 3 to illustrate components of the charging inlet assembly 100) is coupled to a rear of the housing 102 to close out the housing 102 and the internal components of the charging inlet assembly 100. The rear cover 103 may be sealed to the housing 102 to prevent moisture and debris from entering the internal compartment of the housing 102. In an exemplary embodiment, the power connector 101 defines a DC charging portion 104 and an AC charging portion 106. The charging portions 104, 106 may form receptacles or openings that receive a plug of the charging connector. The charging inlet assembly 100 includes a plurality of charging terminals 107 for connection to the charging connector. Power conductors 105 are electrically connected to the charging terminals 107 and routed within the vehicle, such as to the battery. The power conductors 105 may be power cables, busbars, or other types of conductors. The charging terminals 107 and the power conductors 105 form power transmission lines through the vehicle.

The DC charging portion 104 is configured for mating with a DC charging connector or a DC section of the charging connector. The DC charging portion may be used for fast charging. In an exemplary embodiment, the charging terminals 107 of the charging inlet assembly 100 include DC charging terminals 108 at the DC charging portion 104, such as a pair of the DC charging terminals 108. The DC charging terminals 108 are configured to be electrically connected to the DC charging connector. The charging inlet assembly 100 includes DC power conductors 109 (FIG. 2) electrically connected to the DC charging terminals 108. The DC power conductors 109 may be terminated directly to the DC charging terminals 108, such as being crimped or welded to the DC charging terminals 108. In other embodiments, the DC power conductors 109 may be electrically connected to the DC charging terminals 108 through a separable interface, such as through connectors mated to the housing 102 at the rear. The DC charging terminals 108 and the DC power conductors 109 form power transmission lines through the vehicle.

The AC charging portion 106 is configured for mating with an AC charging connector or an AC section of the charging connector. In an exemplary embodiment, the charging terminals 107 of the charging inlet assembly 100 includes AC power terminals 110 at the AC charging portion 106, such as a pair of the AC power terminals 110. The charging terminals 107 of the charging inlet assembly 100 include a proximity terminal 112 at the AC charging portion 106. The charging terminals 107 of the charging inlet assembly 100 include a ground terminal 114 at the AC charging portion 106. The charging terminals 107 of the charging inlet assembly 100 include a communication terminal 116 at the AC charging portion 106. The AC power terminals 110, the proximity terminal 112, the ground terminal 114, and the communication terminal 116 are configured to be electrically connected to the AC charging connector.

The charging inlet assembly 100 includes AC conductors 111 (FIG. 2) electrically connected to the corresponding AC terminals 110, 112, 114, 116. The AC conductors 111 may be terminated directly to the AC terminals 110, 112, 114, 116, such as being crimped or welded thereto. In other embodiments, the AC conductors 111 may be electrically connected to the AC terminals 110, 112, 114, 116 through a separable interface, such as through connectors mated to the housing 102 at the rear. The AC charging terminals 110 and the AC power conductors 111 form power transmission lines through the vehicle.

The conductors 109, 111 extend from the charging inlet assembly 100 to another component of the vehicle, such as the battery system of the vehicle. The conductors 109, 111 transmit power, such as to the battery of the vehicle. The DC power conductors 109 may transmit high voltage for charging the battery and the AC conductors 111 may transmit low voltage for charging the battery. Optionally, one or more of the conductors 111 may be electrically connected to a battery control unit (not shown) of the battery system, such as to transmit data between the charging inlet assembly 100 and the battery system, such as data relating to the charging operation. For example, the conductor 111 may transmit data relating to charging start/stop, operating temperature of the power terminals 108 and/or 110, or other charging data. The conductor 111 may send a proximity signal to the battery system indicating when the charging device is mated to the power connector 101 of the charging inlet assembly 100.

The charging inlet assembly 100 includes a mounting flange 120 (FIG. 1) coupled to the housing 102. The mounting flange 120 is used to couple the charging inlet assembly 100 to the vehicle. The mounting flange 120 includes mounting tabs 122 having openings 124 that receive fasteners (not shown) used to secure the charging inlet assembly 100 to the vehicle. Other types of mounting features may be used to secure the charging inlet assembly 100 to the vehicle. The mounting flange 120 may include a seal to seal the charging inlet assembly 100 to the vehicle.

In an exemplary embodiment, the charging inlet assembly 100 includes a terminal cover 126 (FIG. 2) at a front 130 of the housing 102. The terminal cover 126 is hingedly coupled to the mounting flange 120 and/or the housing 102. The terminal cover 126 is used to cover portions of the housing 102, such as the power connector 101. The terminal cover 126 may be used to cover the DC charging terminals 108 and/or the AC power terminals 110, which are located in corresponding terminal channels 128 in the housing 102.

The rear cover 103 is provided at a rear 132 of the housing 102 to close access to a rear chamber 133 at the rear 132 of the housing 102. The rear cover 103 may be clipped or latched onto the main part of the housing 102, such as using clips or latches. Other types of securing features, such as fasteners may be used in alternative embodiments. A perimeter seal may be provided between the rear cover 103 and the housing 102.

In an exemplary embodiment, the housing 102 of the charging inlet assembly 100 includes an internal cavity 134 that receives the components of the charging inlet assembly 100. The rear chamber 133 is at the rear of the internal cavity 134. The internal cavity 134 includes the terminal channels 128 that receive the corresponding charging terminals 107. The terminal channels 128 may be separated from each other and other components by walls of the housing 102. The internal cavity 134 includes a front chamber 138 at the front that receives the charging connector.

In an exemplary embodiment, the charging inlet assembly 100 includes a charging controller 140 for controlling charging of the vehicle through the charging inlet assembly 100. The charging controller 140 (or components thereof) may be received in the internal cavity 134, such as in the rear chamber 133. The charging controller 140 may be communicatively coupled to the other charging component, such as the charging connector or plug, to control the charging activity or to another charging controller (for example, within the battery distribution unit) within the vehicle for controlling the charging process. The charging controller 140 may be communicatively coupled to the charging connector through one or more of the terminals 107. The charging controller 140 may turn on the power supply, turn off the power supply, increase the power supply, and/or decrease the power supply. The charging controller 140 may be located remote from the housing 102, such as at the battery control module of the vehicle charging system.

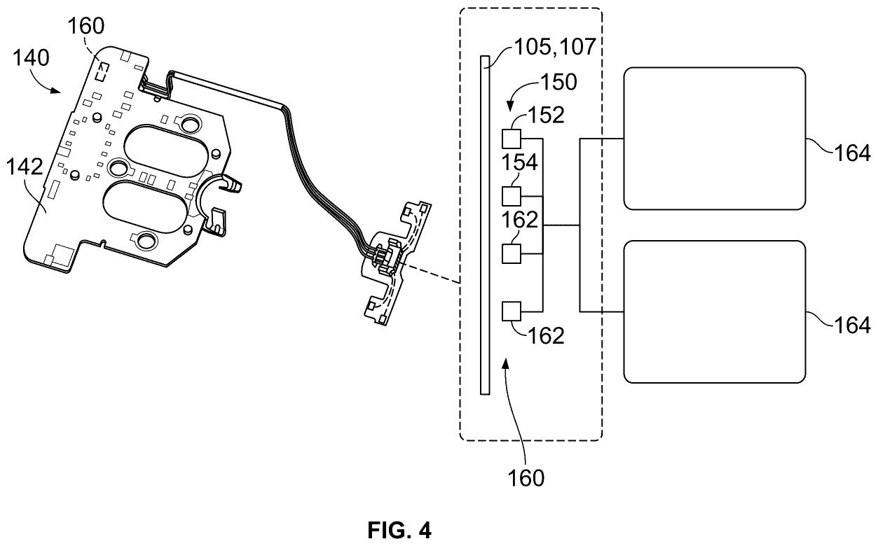

With additional reference to FIG. 4, which is a perspective view of the charging controller 140 in accordance with an exemplary embodiment, the charging controller 140 includes a circuit board 142, a control device 144, and other various components and circuitry to control operation of the charging inlet assembly 100. The control device 144 may be a processor or microcontroller. The control device 144 may include a multi-pin connector coupled to the circuit board 142.

In an exemplary embodiment, the control assembly includes one or more sensors 150 used to control the charging operation. The sensors 150 are used to sense operating characteristics of the components or the charging process to control charging. The sensors 150 are connected to the charging controller 140, such as being connected to the circuit board 142 by a wire or connector.

In various embodiments, the sensors 150 include temperature sensors 152. The temperature sensors 152 monitor operating temperatures of the DC charging terminals 108. The charging operation may be controlled based on the operating temperatures of the DC charging terminals 108. For example, as the temperature increases or approaches an allowable operating temperature, the power supply may be decreased. For example, the voltage or current may be reduced. The charging operation may stop if the operating temperature of the DC charging terminals 108 is above a threshold temperature. The temperature sensor 152 may be used for arc detection, such as by monitoring for a spike in temperature or a temperature above a threshold temperature, which may be higher than a normal operating temperature range.

In various embodiments, the sensors 150 include one or more current sensors 154 monitoring current transmitted along the power transmission lines. A spike in the current or a current above a threshold (for example, above a normal charging level), may indicate an arc event. The charging operation may be controlled based on the sensed current. For example, the charging operation may stop if the arc event is detected. The sensors 150 may include additional systems to help identify false positive arc events and/or to reduce noise, thereby allowing charging to continue if the detected event is a false positive arc event.

In an exemplary embodiment, the sensors 150 include an arc detection antenna 160 coupled to the charging controller 140. The arc detection antenna 160 is configured to be positioned proximate to the power transmission lines for detecting arc signatures along the power transmission lines from an arc event. The arc detection antenna 160 transmits an arc output signal to the charging controller 140. The arc output signal may be based on detection of the arc signature.

In an exemplary embodiment, the arc detection antenna 160 discriminates between common mode and differential mode signals to identify false positive arc events. For example, in the differential mode, the arc detection antenna 160 is able to identify effects of external signals, such as inverter ripple or signals other than the from the charging source, on the power transmission lines to identify false positive arc signatures. In the common mode, the arc detection antenna 160 is able to identify effects of arc signals on the power transmission lines, such as to confirm that arc signals occur on the power transmission lines. In an exemplary embodiment, the arc detection antenna 160 can discriminate between common mode (for example, arc) and differential mode (for example, inverter ripple), such as based on amplitude and/or phase of the signals. Inverter ripple or arc noise from an adjacent car may both appear as common mode, but at much lower amplitude, to help identify false positive signatures. In an exemplary embodiment, the arc detection antenna 160 may determines magnitudes of arc signals on the power transmission lines and may determine phases of the arc signals on the power transmission lines. In the differential mode, the signals may be equal in magnitude but opposite in phase and thus would essentially cancel out, indicating that the detected signals are generated on the signal transmission lines and the arc event is occurring within the charging inlet assembly 100. However, in the common mode, because the signals are produced from a different source (for example, inverter ripple or an arc event at a nearby vehicle charging at a different charging station), the signals would be received by both power transmission lines. Thus, the signals would be equal in magnitude and in the same phase, indicating that the signals are generated from an external source thus identifying a false positive arc event on the vehicle being monitored. Discrimination between the common mode and the differential mode allows the system to accurately distinguish between an arc event and a false positive arc event.

In various embodiments, the arc detection antenna 160 is incorporated into the charging controller 140, such as being incorporated into the circuit board 142. In other various embodiments, the arc detection antenna 160 may be located remote from the charging controller and coupled thereto either by a wired or wireless connection. The arc detection antenna 160 may be connected to the charging controller 140 by wiring, such as single ended wires or by a controlled impedance transmission line structure. The signals from the arc detection antenna 160 may be processed, such as by low noise amplification and/or filtering along the signal paths. The controlled impedance connection may allow increased flexibility of the location of the detector circuitry compared to the antenna elements. The arc detection antenna 160 may be located within the housing 102, such as in the internal cavity 134. As such, the arc detection antenna 160 may be located proximate to the charging terminals 107 and/or the ends of the power conductors 105. In other various embodiments, the arc detection antenna 160 may be located remote from the housing 102, such as along the power conductors 105 outside of the housing 102 or in the battery assembly, such as in the battery distribution unit (BDU).

The arc detection antenna 160 includes one or more antenna element(s) 162 for detecting signals around/along the power transmission lines and one or more antenna circuits 164 for transmitting signals from the antenna elements 162. The antenna circuits 164 may include processing devices, such as a digital signal processor, a neural network, frequency diplexers, and the like, to process the signals. The antenna elements 162 may include e-field antenna elements and/or b-field antenna elements. The antenna elements 162 may measure electrostatic signals. The antenna elements 162 may measure magnetic signals. Other types of antenna elements may be used in alternative embodiments. In an exemplary embodiment, the antenna elements 162 and the antenna circuits 164 may be used for detecting signals in different modes. The antenna elements 162 and the antenna circuits 164 may be used for detecting signals on different power transmission lines. The different antenna elements 162 and antenna circuits 164 may detect signals in different frequency ranges.

The antenna circuits 164 are coupled to the charging controller 140. For example, the antenna circuits 164 transmit an output (for example, arc signal output) to the charging controller 140. The charging controller 140 may include processing devices, such as a microcontroller, a processor, a digital signal processor, a neural network, frequency diplexers, and the like, to process the signals. The charging controller 140 is used to control the charging operation. For example, the charging controller 140 may turn on the power supply, turn off the power supply, increase the power supply, and/or decrease the power supply based on the signals from the antenna circuits 164 (for example, based on the current output signal). For example, when the arc event is detected, the charging operation is stopped. The current and voltage from the charging connector is stopped immediately to prevent damage to the components or the vehicle.

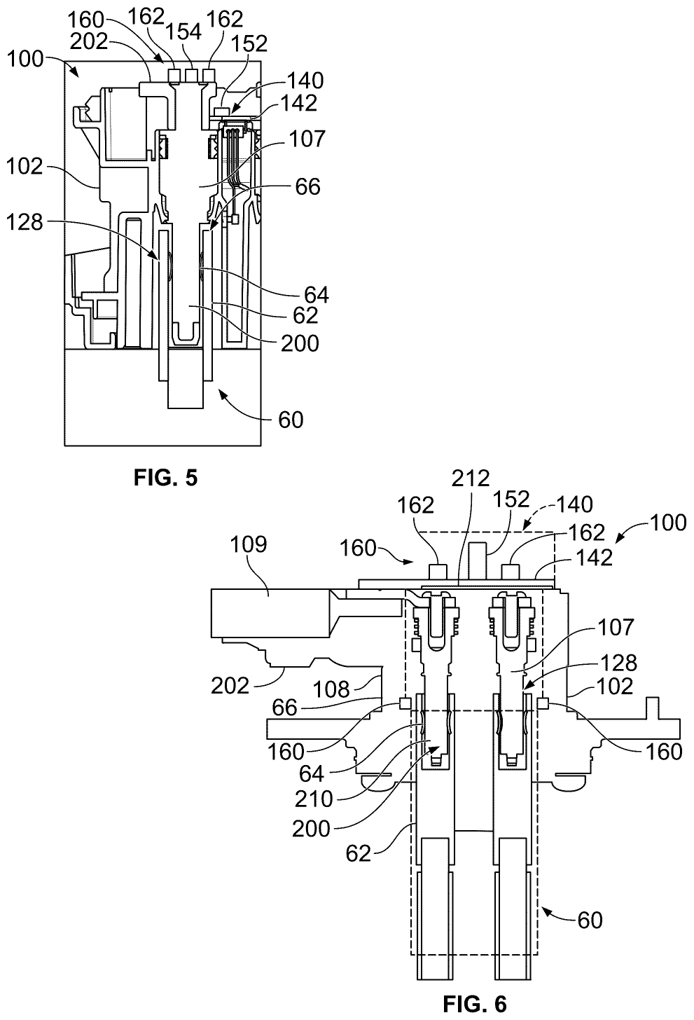

FIG. 5 is a cross-sectional view of the charging component 100 in accordance with an exemplary embodiment showing a second charging component 60 coupled to the charging component. FIG. 6 is a cross sectional view of the charging component 100 in accordance with an exemplary embodiment showing the second charging component 60 coupled to the charging component. In the illustrated embodiment, the charging component 100 is the charging inlet assembly. The second charging component 60 is a charging connector such as a plug charger.

The charging terminals 107 are shown in the terminal channels 128 of the housing 102. The charging terminals 107 are mated with charging terminals 62 of the charging connector 60. In the illustrated embodiment, the charging terminals 107 are pin terminals and the charging terminals 62 are socket terminals having spring contacts 64 in the sockets configured to electrically connect the charging terminals 62 and the charging terminals 107. The spring contacts 64 form a compliant, separable interface. The spring contacts 64 may be susceptible to failure due to overheating, and the failure may lead to an electrical arc event. The temperature sensors 152 monitor temperature of the charging terminals 107. The antenna elements 162 monitor the current transmitted along the power transmission line (for example, along the charging terminal 107). In an exemplary embodiment, the antenna elements 162 monitor the electromagnetic fields, such as radio frequency signals) on the power transmission line for arc events, such as at mating ends 66 of the charging terminals 62 or mating ends of the charging terminals 107.

The charging terminal 107 includes a mating pin 200 at a mating end 210 of the charging terminal 107 and a cable connector 202 at a rear 212 of the charging terminal 107. The charging terminal 107 extends along a longitudinal axis. The mating pin 200 is configured to be mated to the spring contact 64 of the charging terminal 62 of the charging connector 60. The cable connector 202 is configured to be electrically connected to the power conductor 109. In various embodiments, the cable connector 202 is configured to be terminated to the power conductor 109 by crimping to the power conductor 109. In other various embodiments, the cable connector 202 is terminated to the power conductor 109 by other processes, such as being welded to a weld tab at the rear end of the charging terminal 107. The conductor 109 may extend from the charging terminal 107 perpendicular to the longitudinal axis. Alternatively, the conductor 109 may extend from the charging terminal 107 parallel to the longitudinal axis.

In an exemplary embodiment, the temperature sensor 152 is coupled to the charging terminal 107 at the rear of the charging terminal 107, such as at the cable connector 202. The charging terminal 107 is both electrically conductive and thermally conductive. As the mating pin 200 heats up during charging, the entire body of the charging terminal 107 similarly heats up. Such increase in temperature is detected by the temperature sensor 152. In various embodiments, the temperature sensor 152 is a thermistor. The temperature sensor 152 may include a resistance temperature detector.

The arc detection antenna 160 monitors the RF signals along the power transmission line. Monitoring the electromagnetic fields allows the arc detection antenna 160 to detect an arc event along the power transmission line. Monitoring the electromagnetic fields may allow the arc detection antenna 160 to detect false positive arc events occurring external to the power transmission line, such as occurring on a different vehicle at the charging station or other external events that could lead to a spike in RF signals on the power transmission lines. By detecting the arc event, the arc detection antenna 160 is able to signal to the charging controller 140 to shut down the charging operation to protect the components of the charging inlet assembly 100 and the vehicle.

In various embodiments, the arc detection antenna 160 monitors for an arc noise signature to detect the arc event. For example, arc noise is generated by the arc event, such as in the radiofrequency range as a consequence of arc energy. The characteristic noise signature of the electrical arcing may be in a predetermined range, such as between 1 kHz-100GHz. The characteristic noise signature of the electrical arcing may be in a more particular range, such as between 100-500 kHz. The arc detection antenna 160 detects the stochastic energy, or noise signature, generated by the electrical arc. In an exemplary embodiment, the arc detection antenna 160 may monitor the power transmission line of the charging inlet assembly 100 to detect the arc noise signature on the power transmission line corresponding to the arc event. The arc detection antenna 160 may monitor the current along the charging terminals 107 and/or the power conductors 109.

In various embodiments, the charging controller 140 may include an arc fault circuit interrupter (AFCI) device to protect against electrical arcing, such as to shut down the charging circuit when an arc is detected. The antenna element 162 monitors for the arc noise signature on the electrical circuit to detect the arc noise signature conducted on the power transmission line when the arc fault occurs. The charging controller 140 may include an internal processor in the ACFI device that distinguishes between normal operation and the hazardous arcing and will automatically open the circuit to reduce the risk of damage to the system.

In various embodiments, the arc detection antenna 160 is connected to other wiring or circuits to detect the arc noise signature. The arc detection antenna 160 may be located at the battery, such as at the battery distribution unit (BDU) rather than at the charging inlet housing. In other various embodiments, the arc detection antenna 160 includes a separate, dedicated arc detection wire, which may be routed from the charging terminal 107 to the circuit board 142 or routed to another component, such as the battery control module. The arc detection antenna 160 may include a resistor-capacitor- inductor network or filter at the charging terminal 107 or at the circuit board 142 to enhance sensitivity to arc signature and minimize sensitivity to normal vehicle electrical noise.

In an exemplary embodiment, the antenna element 162 is electrically coupled to the power transmission line at or near the cable connector 202 at the rear 212 of the charging terminal 107. The antenna element 162 may be coupled to the cable connector 202 or to the conductor 109. In various embodiments, the antenna element 162 may be located between two different power lines to measure signals from both power transmission lines. In various embodiments, different antenna elements 162 may be provided for each of the power transmission lines to monitor the respective power transmission lines to monitor the electrical signature along such power transmission lines. The arc detection antenna 160 may compare the signals from the different antenna elements 162 to determine if an arc event is occurring and/or to determine if a false positive arc event is occurring.

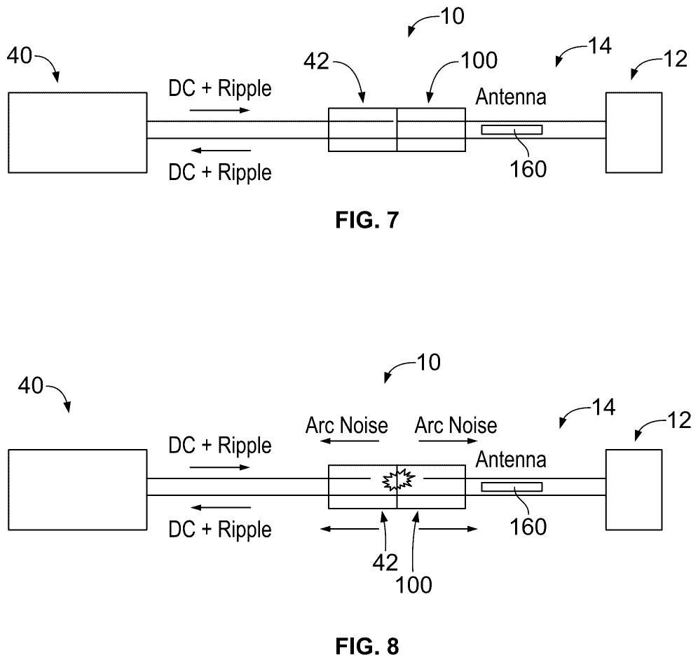

FIG. 7 is a schematic view of the vehicle charging system 10 in accordance with an exemplary embodiment in a differential mode. FIG. 8 is a schematic view of the vehicle charging system in accordance with an exemplary embodiment in a common mode.

The vehicle charging system 10 includes the charging connector 42 and the corresponding first and second power transmission lines (for example, cables/charging terminals) of the dispenser or charging station 40, and the charging inlet assembly 100, the battery 12, and the corresponding first and second power transmission lines (for example, cables/charging terminals) of the vehicle 14. The arc detection antenna 160 is provided, such as between the power transmission lines of the vehicle 14 (and/or between the power transmission lines of the charging station 40).

During charging, the dispenser produces a DC current to charge the battery. To save weight and cost, the dispenser may use a switching power supply rather than a linear power supply, which superimpose a small AC ripple current on the DC charging current. The ripple current is typically of no consequence to the battery being charged, however its dominant frequency content of 50-1000 kHz substantially overlaps the 100-1500 kHz frequency spectrum of an arc. That overlap can make arc detection by spectrum analysis problematic. The conductors of a charging system are routed closely parallel to each other. This close, parallel spacing can be exploited by the arc detection antenna 160 to discriminate between arc and ripple signals, such as by placing the arc detection antenna 160 between the two conductors.

In the differential mode (FIG. 7), the DC current and the AC ripple current flow past the antenna with equal but opposite phase. The DC signal introduces no current into the antenna, but the time-varying ripple current will. Since the ripple current flows in opposite directions on each side of the arc detection antenna 160, the electromagnetic fields cancel and no current is induced in the antenna.

In the common mode (FIG. 8), when external signals are introduced to the system, such as from an arc generated in one of the contacts or from inverter ripple or an arc event at a nearby vehicle charging at a different charging station, the noise (for example, arc signal or inverter ripple signal) travels along each power transmission line in the same direction, such as in a direction away from the arc itself. Since the power transmission lines are close together the noise generated in the first power transmission line induces a similar but slightly smaller current in the second power transmission line. The noise flowing along each wire induces a current in the arc detection antenna 160, and since the currents are in phase their fields add and induce a current in the arc detection antenna 160.

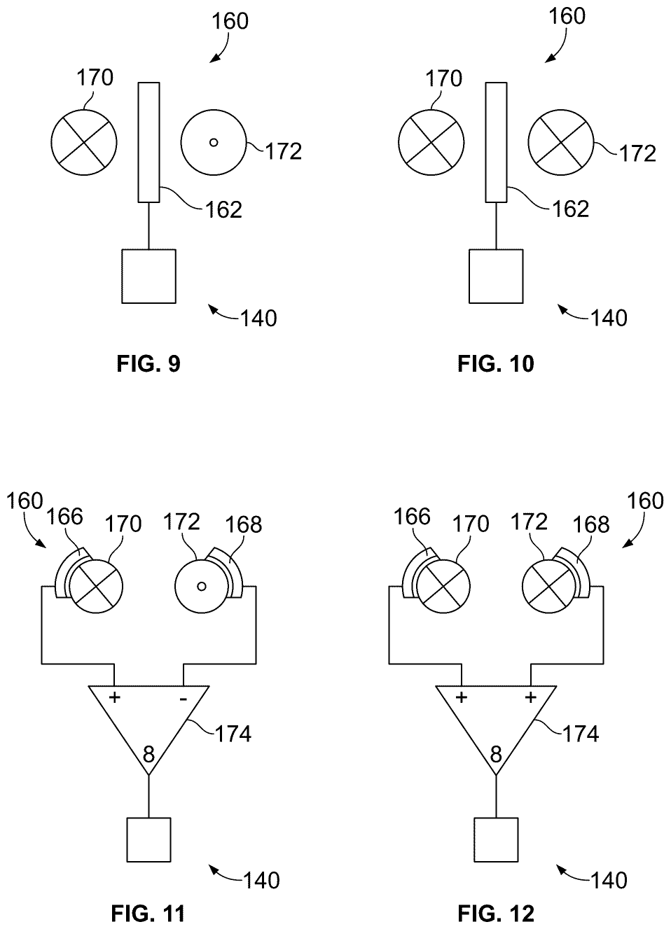

FIG. 9 is a schematic view of a portion of the charging inlet assembly 100 showing an arrangement of the arc detection antenna 160 in accordance with an exemplary embodiment in a first mode (differential mode). FIG. 10 is a schematic view of a portion of the charging inlet assembly 100 showing an arrangement of the arc detection antenna 160 in accordance with an exemplary embodiment in a second mode (common mode).

In an exemplary embodiment, the arc detection antenna 160 includes a single antenna element 162 located between the first and second power transmission lines 170, 172. The antenna element 162 may be approximately centered between the first and second power transmission lines 170, 172. The antenna element 162 receives RF signals from both the first and second power transmission lines 170, 172. For example, the antenna element 162 detects electromagnetic fields from both the first and second power transmission lines 170, 172.

In an exemplary embodiment, the arc detection antenna 160 discriminates between common mode and differential mode signals to identify false positive arc events. For example, in the common mode (FIG. 9), the arc detection antenna 160 is able to identify effects of arc signals on the power transmission lines, such as to confirm that arc signals occur on the power transmission lines. In the differential mode (FIG. 10), the arc detection antenna 160 is able to identify effects of external signals, such as inverter ripple and/or signals from external sources, on the power transmission lines 170, 172 to identify false positive arc signatures.

In an exemplary embodiment, the arc detection antenna 160 determines magnitudes of RF signals on the power transmission lines and determines phases of the RF signals on the power transmission lines. During charging, current flows along the power transmission lines 170, 172. The charging current is conducted along the power transmission lines 170, 172 in a closed loop. The charging current, in the power transmission lines 170, 172, is equal in magnitude and opposite in phase (for example, into the page along line 170 and out of the page along line 172). The antenna element 162 is located between the power transmission lines 170, 172 such that differential mode signals produce an equal but opposite response in the arc detection antenna 160. The arc detection antenna 160 is largely insensitive to the differential mode signals. When an arc event occurs in the vehicle, the arc signal is transmitted along the power transmission lines 170, 172 in a direction away from the source. Similarly, external signals, such as inverter ripple noise or arc noise from an adjacent car, are introduced into the power transmission lines and travel in a direction away from the source. The currents are in phase and their fields add and induce a current in the arc detection antenna 160. As such, the arc detection antenna 160, and the charging controller 140 coupled to the arc detection antenna 160, is able to verify that the arc event (for example, sensed by other sensors such as the temperature sensor and/or the current sensor) is occurring and the charging operation is shut down. The arc detection antenna 160 uses the common mode signals to verify the arc event to control the charging operation indicating that the detected signals are generated on the signal transmission lines 170, 172 and the arc event is occurring within the charging inlet assembly 100. Moreover, external signals, such as an arc event in a nearby vehicle, would be impressed on the power transmission lines 170, 172 (for example, the electromagnetic fields from the nearby arc event would be transmitted or radiated along the power transmission lines 170, 172). The external signals would be received by both of the power transmission lines 170, 172 with nearly equal magnitude and in the same phase (for example, out of the page along both lines 170, 172) and thus form common mode signals along the power transmission lines 170, 172. The arc detection antenna 160 is highly sensitive to the common mode signals because the signals are additive to the antenna element 162. When the common mode signal is detected by the arc detection antenna 160, the arc detection antenna 160 verifies that the signal is a false positive arc signal. Thus the charging operation of the vehicle is able to continue rather than being shut down. Discrimination between the common mode and the differential mode allows the system to accurately distinguish between an arc event and a false positive arc event.

FIG. 11 is a schematic view of a portion of the charging inlet assembly 100 showing an arrangement of the arc detection antenna 160 in accordance with an exemplary embodiment in a first mode (differential mode). FIG. 12 is a schematic view of a portion of the charging inlet assembly 100 showing an arrangement of the arc detection antenna 160 in accordance with an exemplary embodiment in a second mode (common mode).

In an exemplary embodiment, the arc detection antenna 160 includes multiple antenna elements 162, such as a first antenna element 166 located on the first power transmission line 170 and a second antenna element 168 located on the second power transmission line 172. The antenna elements 166, 168 may be located on outer sides of the power transmission lines 170, 172 (for example, away from each other and/or facing outward away from each other) to reduce interference on the respective antenna elements 166, 168 from the power transmission lines 170, 172. For example, the first antenna clement 166 essentially detects electromagnetic fields from the first power transmission line 170 and the second antenna element 168 essentially detects electromagnetic fields from the second power transmission line 172.

In an exemplary embodiment, the arc detection antenna 160 includes a summing amplifier 174 receiving signals from the first and second antenna elements 166, 168. The signals may be processed prior to being transmitted to the summing amplifier 174. The signals may be processed post summing at the summing amplifier 174. The arc detection antenna 160 discriminates between common mode and differential mode signals to identify arc events and false positive arc events. For example, in the common mode (FIG. 11), the arc detection antenna 160 is able to identify effects of arc signals on the power transmission lines, such as to confirm that arc signals occur on the power transmission lines. In the differential mode (FIG. 12), the arc detection antenna 160 is able to identify effects of signals such as inverter ripple on the power transmission lines 170, 172 to identify false positive arc signatures.

In an exemplary embodiment, the arc detection antenna 160 determines magnitudes of RF signals on the power transmission lines and determines phases of the RF signals on the power transmission lines. The charging current and arc signals, in the power transmission lines 170, 172, is equal in magnitude and opposite in phase. Differential mode signals produce equal but opposite response in the arc detection antenna 160 such that the signals from the first and second power transmission lines 170, 172 essentially cancel or negate each other at the summing amplifier 174 such that the arc detection antenna 160 is largely insensitive to the differential mode signals. As such, the arc detection antenna 160, and the charging controller 140 coupled to the arc detection antenna 160, is able to verify that the arc event (for example, sensed by other sensors such as the temperature sensor and/or the current sensor) is occurring in the vehicle and the charging operation is shut down. The arc detection antenna 160 uses the common mode signals to verify the arc event to control the charging operation indicating that the detected signals are generated on the signal transmission lines 170, 172 and the arc event is occurring within the charging inlet assembly 100. Moreover, external signals, such as inverter ripple or an arc event in a nearby vehicle, would be impressed on the power transmission lines 170, 172 (for example, the electromagnetic fields from the nearby arc event would be transmitted or radiated along the power transmission lines 170, 172). The external signals would be received by both of the power transmission lines 170, 172 with nearly equal magnitude and in the same phase and thus form common mode signals along the power transmission lines 170, 172. The arc detection antenna 160 is highly sensitive to the common mode signals because the signals are additive at the summing amplifier 174. The arc detection antenna 160 may verify that the signal is a false positive arc signal. Thus, the charging operation of the vehicle is able to continue rather than being shut down. Discrimination between the common mode and the differential mode allows the system to accurately distinguish between an arc event and a false positive arc event.

It is to be understood that the above description is intended to be illustrative, and not restrictive. For example, the above-described embodiments (and/or aspects thereof) may be used in combination with each other. In addition, many modifications may be made to adapt a particular situation or material to the teachings of the invention without departing from its scope. Dimensions, types of materials, orientations of the various components, and the number and positions of the various components described herein are intended to define parameters of certain embodiments, and are by no means limiting and are merely exemplary embodiments. Many other embodiments and modifications within the spirit and scope of the claims will be apparent to those of skill in the art upon reviewing the above description. The scope of the invention should, therefore, be determined with reference to the appended claims, along with the full scope of equivalents to which such claims are entitled. In the appended claims, the terms “including” and “in which” are used as the plain-English equivalents of the respective terms “comprising” and “wherein.” Moreover, in the following claims, the terms “first,” “second,” and “third,” etc. are used merely as labels, and are not intended to impose numerical requirements on their objects. Further, the limitations of the following claims are not written in means-plus-function format and are not intended to be interpreted based on 35 U.S.C. § 112(f), unless and until such claim limitations expressly use the phrase “means for” followed by a statement of function void of further structure.

What is claimed is:

1. A vehicle charging system for an electric vehicle comprising:
a housing having a mating end for mating with a charging component for the electric vehicle, the housing including an internal cavity;
charging terminals held by the housing in the internal cavity, each charging terminal including a mating end for mating with the charging component, the charging terminals being connected to corresponding power conductors to form power transmission lines;
a charging controller for controlling vehicle charging along the power transmission lines; and
an arc detection antenna coupled to the charging controller, the arc detection antenna positioned proximate to the power transmission lines for detecting arc signatures along the power transmission lines from an arc event, the arc detection antenna transmitting an arc output signal to the charging controller based on detection of the arc signature.

2. The vehicle charging system of claim 1, wherein the arc detection antenna determines magnitudes of arc signals on the power transmission lines and determines phases of the arc signals on the power transmission lines, the arc output signal being based on the magnitudes and the phases of the arc signals.

3. The vehicle charging system of claim 1, wherein the arc detection antenna discriminates between differential mode arc signals and common mode arc signals transmitted along the power transmission lines, the arc output signal being based on the differential mode arc signals and the common mode arc signals.

4. The vehicle charging system of claim 3, wherein the arc detection antenna discriminates between the differential mode arc signals and the common mode arc signals to eliminate false positive identification of an arc event.

5. The vehicle charging system of claim 1, wherein the arc detection antenna determines magnitudes of arc signals on the power transmission lines and determines phases of the arc signals on the power transmission lines, the arc detection antenna discriminating between differential mode signals and common mode signals transmitted along the power transmission lines based on the magnitudes of the arc signals on the power transmission lines and the phases of the arc signals on the power transmission lines.

6. The vehicle charging system of claim 1, wherein the power transmission lines include a first power transmission line and a second power transmission line, the arc detection antenna positioned between the first and second power transmission lines.

7. The vehicle charging system of claim 6, wherein the arc detection antenna is operable in a differential mode to detect a first type of signals on the power transmission lines, and wherein the arc detection antenna is operable in a common mode to detect a second type of signals on the power transmission lines.

8. The vehicle charging system of claim 1, wherein the power transmission lines include a first power transmission line and a second power transmission line, the arc detection antenna including a first antenna element positioned proximate to the first power transmission line and a second antenna element positioned proximate to the second power transmission line.

9. The vehicle charging system of claim 8, wherein the arc detection antenna includes a summing amplifier processing signals from the first and second antenna elements.

10. The vehicle charging system of claim 9, wherein the signals from the first and second antenna elements are summed in phase relative to each other being responsive to common mode currents.

11. The vehicle charging system of claim 9, wherein the signals from the first and second antenna elements are summed out of phase relative to each other being responsive to differential mode currents.

12. The vehicle charging system of claim 1, wherein the arc detection antenna monitors the arc signals at the power conductors.

13. The vehicle charging system of claim 1, wherein the arc detection antenna monitors the arc signals at the charging terminals.

14. The vehicle charging system of claim 1, wherein the arc detection antenna is located in the internal cavity of the housing.

15. The vehicle charging system of claim 1, wherein the arc detection antenna is located in a battery distribution unit of a battery system of the electric vehicle.

16. The vehicle charging system of claim 1, wherein the charging controller shuts power supplied to the charging terminals when the arc event is detected.

17. The vehicle charging system of claim 1, wherein the housing is a charging connector housing configured to be removably coupled to a charging inlet housing of the charging component of the vehicle, the charging terminals being socket terminals configured to be mated with pin terminals of the charging component to power the vehicle through the pin terminal.

18. The vehicle charging system of claim 1, wherein the housing is a charging inlet housing configured to be mounted to the vehicle and configured to receive a charging connector housing of the charging component, the charging terminals including pins configured to be mated with socket terminals of the charging component to receive power from the charging component.

19. A vehicle charging system for an electric vehicle comprising:
a housing having a mating end for mating with a charging component for the electric vehicle, the housing including an internal cavity;
charging terminals held by the housing in the internal cavity, each charging terminal including a mating end for mating with the charging component, the charging terminals being connected to corresponding power conductors to form power transmission lines;
a charging controller for controlling vehicle charging along the power transmission lines; and
an arc detection antenna coupled to the charging controller, the arc detection antenna positioned proximate to the power transmission lines for detecting arc signatures along the power transmission lines from an arc event, the arc detection antenna determining magnitudes of arc signals on the power transmission lines and determining phases of the arc signals on the power transmission lines, the arc detection antenna discriminating between differential mode signals and common mode signals transmitted along the power transmission lines based on the magnitudes of the arc signals on the power transmission lines and the phases of the arc signals on the power transmission lines, the arc detection antenna processing the magnitudes, the phases, and the modes to generate an arc output signal, the arc output signal being transmitted to the charging controller to control the vehicle charging.

20. A charging inlet assembly for an electric vehicle comprising:
a housing extending between a front and a rear, the housing having a chamber at the rear, the housing having a power connector at the front for receiving a charging connector, the power connector including terminal channels between the front and the rear;
charging terminals received in the corresponding terminal channels, each of the charging terminals including a mating pin and a terminating end opposite the mating pin, the mating pin positioned in the corresponding terminal channel for mating with the charging connector, the terminating end positioned in the chamber at the rear of the housing and being connected to a power conductor to form a power transmission line;
a charging controller for controlling vehicle charging along the power transmission lines during a charging operation; and
an arc detection antenna coupled to the charging controller, the arc detection antenna positioned proximate to the power transmission lines for detecting arc signatures along the power transmission lines from an arc event, the arc detection antenna determining magnitudes of arc signals on the power transmission lines and determining phases of the arc signals on the power transmission lines, the arc detection antenna discriminating between differential mode signals and common mode signals transmitted along the power transmission lines based on the magnitudes of the arc signals on the power transmission lines and the phases of the arc signals on the power transmission lines, the arc detection antenna processing the magnitudes, the phases, and the modes to generate an arc output signal, the arc output signal being transmitted to the charging controller to control the vehicle charging.
